(19) United States
(12) Patent Application Publication
(10) Pub. No.: US 2016/0107201 A1
(43) Pub. Date: Apr. 21, 2016

(54) CLEAiR, CLEAiR 2.0

(71) Applicant: John Calvin Oswald, Houston, MN (US)

(72) Inventor: John Calvin Oswald, Houston, MN (US)

(21) Appl. No.: 14/519,775

(22) Filed: Oct. 21, 2014

(51) Int. Cl. B08B 5/02; G02B 27/00

(52) U.S. Cl. CPC B08B 5/02; G02B 27/0006

(57) ABSTRACT

Immediate clearing of the field of view for a visual or photographic device is often essential and somewhat complicated. This loss of time and vision can have consequences on image capture quality, workman's performance, and workman's safety. The CLEAiR remedies this by pressurized air and fluid discharge over the device's area of view during live action viewing and recording. The CLEAiR 2.0 further remedies these problems by fine tune adjustment of the location and angle of incidence of the discharged air/fluid over the device's area of view. With these inventions attached to a visual/photographic device, continuous work or filming is possible without loss of time, loss of image quality, or loss of user safety.

### CROSS REFERENCE

This application has no co-pending or previously filed relation to a previous application.

### FEDERAL FUNDING

No federal support is given for these inventions.

### JOINT RESEARCH

No joint research agreements exist.

### SUMMARY

Clear view in dirty and/or hazardous environments is often essential. From rescue operations to video recordings, staying focused on the subject at hand is important. Such things as the obstruction of sight due to invasive particles is always a concern. Wiping protective equipment on site is time consuming and not always effective. Removal of protective equipment for cleaning on site brings health risks. Obscured photographic lenses create picture aberrations. Removal of a photographic lens from the subject for cleaning causes loss of photographic opportunities.

### DRAWINGS DESCRIPTIONS

The CLEAiR and CLEAiR 2.0 provide solutions to these problems with pressurized volumes of air and/or cleaning fluid ejected over the viewing area surface for active, on-site clearing.

FIG. 1 gives a side view of the CLEAiR (page 9). FIG. 1 depicts a valve at the close end (coming out of the page). The following designated symbols for components of FIG. 1 depict the following: 1a depicts the valve for allowing air/fluid entry, 1b depicts the tubing itself for containing the air/fluid, 1c depicts the internal chamber of the tube where the air/fluid collects, and 1d depicts the opening to allow for air/fluid discharge with air/fluid flow in the direction of the arrow.

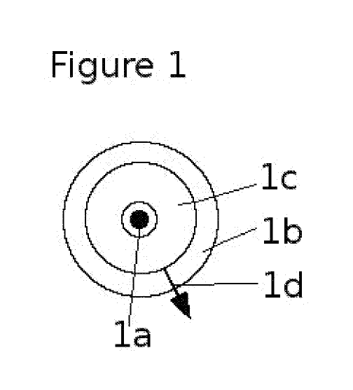

FIG. 2 gives a front view of the CLEAiR with arrows depicting air/fluid flow (page 10). The following designated symbols for components of FIG. 2 depict the following: 2a depicts the valves for allowing air/fluid entry, 2b depicts air/fluid flow in the direction of the arrows, and 2c depicts the discharge vent.

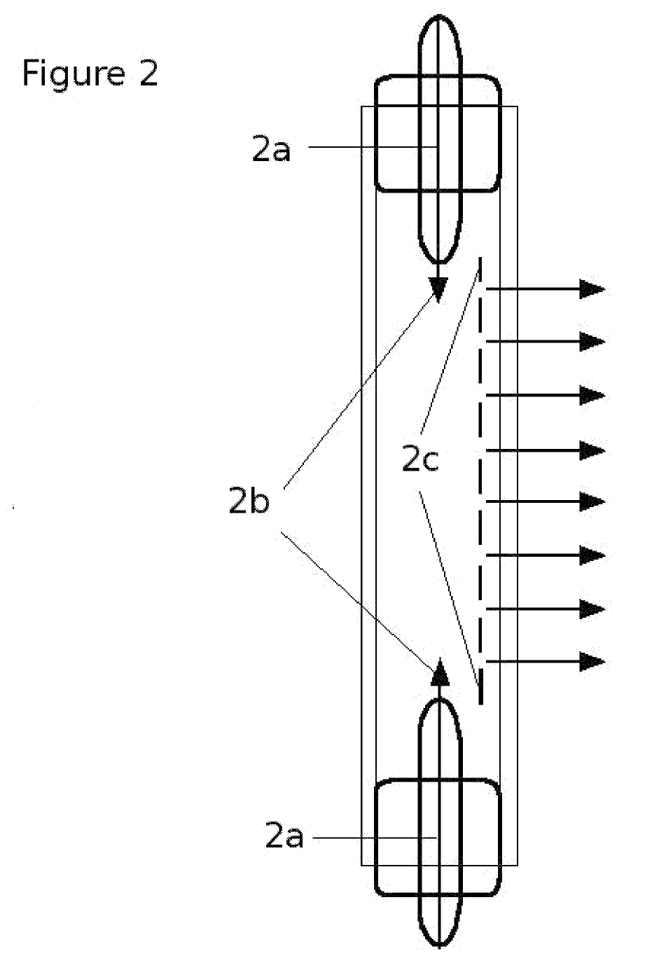

FIG. 3 gives a side view of the CLEAiR 2.0 mounted to a photographic device (page 11). The following designated symbols for components of FIG. 3 depict the following: 3a depicts the valve for allowing air/fluid entry, 3b depicts air/fluid flow in the direction of the arrows, 3c depicts the scaffold for the CLEAiR 2.0, 3d depicts the camera, and 3e depicts the camera lens.

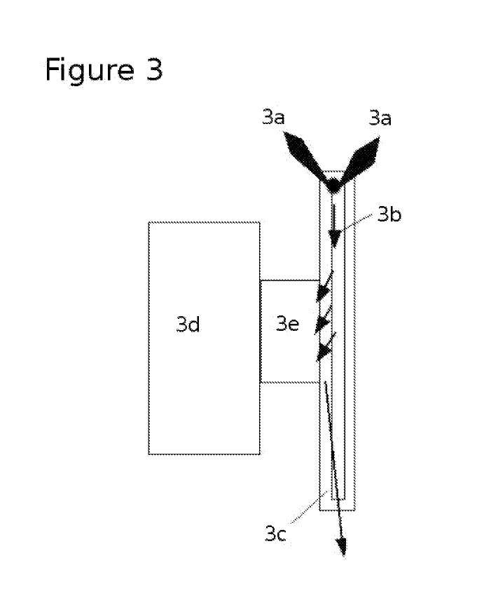

FIG. 4 gives a front view of the CLEAiR 2.0 with arrows depicting air/fluid flow (page 12). The following designated symbols for components of FIG. 4 depict the following: 4a depicts the valve for allowing air/fluid entry, 4b depicts air/fluid flow in the direction of the arrows, 4c depicts the scaffold for the CLEAiR 2.0, and 4d depicts the camera lens.

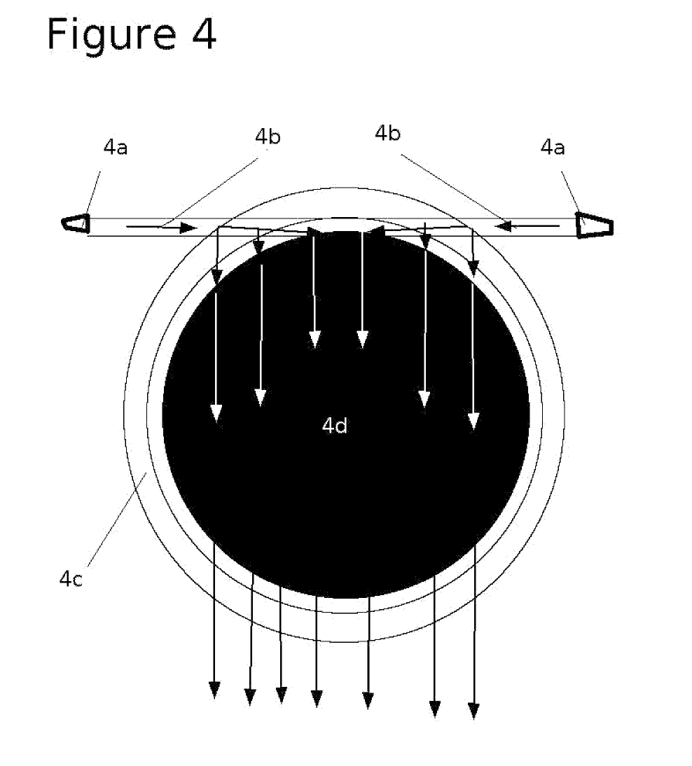

### INVENTION CONSTRUCTION

My innovation and inventions, the CLEAiR and CLEAiR 2.0, act as solutions to the afore mentioned problems. The following material is needed for the CLEAiR: vinyl tubing, metal valves, a pressurized air source, a pressurized fluid source, and a razor blade. In addition to the CLEAiR material, the CLEAiR 2.0 requires the following: 3 to 4 step up/down single-lens reflex (SLR) adapter rings, a rotating ring, a machine shop mill, and an end mill bit the size of the CLEAiR vinyl tubing outer diameter. Refer to the following assembly instructions:

### CLEAiR Assembly Instruction

1) With the razor blade, cut the vinyl tubing to the appropriate length.
2) Insert the valves into either end of the vinyl tubing.
3) With the razor blade, cut the vinyl tubing lengthwise between the valves to create a discharge vent.
4) Attach or mount the cut tubing with valves, the CLEAiR, over the viewing area of the device with the vent pointing at the most effective angle of incidence.
5) Attach the pressurized air source and/or fluid source to the valves.

### CLEAiR 2.0 Assembly Instruction

1) Screw the 3-4 SLR adapter rings together to make a cylinder.
2) Bore 2 straight holes through the cylinder with the mill and the end mill bit (be sure the hole line is outside the camera's field of view).
3) Attach the rotating ring to the back of the drilled cylinder.
4) Detach the CLEAiR valves, insert the CLEAiR tube through the two holes of the cylinder, and reattach the CLEAiR valves.
5) The CLEAiR 2.0 can be attached to any SLR camera * or device **.
   * The rotating ring size must match that of the camera lens.
   ** Rotating ring must be equal to or larger than the viewing area and securely fastened.

The tubing contains an opening the length of the viewing region and a width of 200-400 μm (or a razor's cut width) for air/fluid discharge. The valves are connected to pressurized air source(s) and/or fluid source(s). The pressurized air/fluid is discharged through the tube's vent and over the viewing area. This clears and cleans the viewing area to allow for working and photographing in obstructive environments without visual interference or interruption. The CLEAiR 2.0 enables the turning of the tube to adjust the angle of incidence of the air/fluid discharge and the rotation of the tube to adjust the tube's location relative to the device's area of view.

1. The immediate discharge of pressurized air and/or fluid to clean and clear the viewing area of visual or recording devices via my CLEAiR invention.

2. The maneuverability of the CLEAiR around the area of view of the device allowing for precise cleaning and clearing: my invention the CLEAiR 2.0.
